(19) United States
(12) Patent Application Publication
(10) Pub. No.: US 2020/0052314 A1
(43) Pub. Date: Feb. 13, 2020

(54) FUEL CELL SYSTEM AND METHOD FOR PERFORMING THERMAL REGENERATION OF DESULFURIZATION ADSORBATES

(71) Applicant: AVL List GmbH, Graz (AT)

(72) Inventor: Raphael NEUBAUER, Graz (AT)

(73) Assignee: AVL List GmbH, Graz (AT)

(21) Appl. No.: 16/492,614

(22) PCT Filed: Mar. 9, 2018
(86) PCT No.: PCT/EP2018/055864

§ 371 Date: Sep. 10, 2019

(30) Foreign Application Priority Data
Mar. 10, 2017 (AT) A 50192/2017

(51) Int. Cl. H01M 8/0662; H01M 8/0612; H01M 8/04014; H01M 8/04082; B01D 53/04

(52) U.S. Cl. CPC H01M 8/0675; H01M 8/0618; H01M 8/04022; H01M 8/04201; B01D 53/0438; B01D 2259/4566; H01M 2250/407; H01M 2250/20; B01D 2257/30; B01D 2259/4009; B01D 53/0446

(57) ABSTRACT

The present invention relates to a fuel cell system (100a, 100b, 100c) comprising a fuel cell stack (5) having an anode portion (5a) and a cathode portion (5b), a reformer (3) for reforming fuel for use in the anode portion (5a) of the fuel cell stack (5), and a fuel tank (1) for providing the fuel to the reformer (3), wherein downstream of the fuel tank (1) and upstream of the reformer (3) there is located a desulphurization unit (2) with an adsorber (2a) for the adsorptive desulphurization of fuel, which is conducted from the fuel tank (1) via the desulphurization unit (2) to the reformer (3), wherein the adsorber (2a) is provided with anodes (5a) and cathode portions (5b) and/or an internal combustion engine (11) of the fuel cell system (100a; 100b; 100c) is in fluid communication by means of a regeneration fluid line (12), wherein fluid heated by the regeneration fluid line (12) can be conveyed from the anode portion (5a) and cathode portion (5b) and/or from the internal combustion engine (11) to the adsorber (2a). The invention also concerns a method for the thermal regeneration of desulphurization adsorbates and a motor vehicle equipped with the fuel cell system (100a, 100b, 100c) in accordance with the invention.

The present invention relates to a method for a thermal regeneration of desulphurization adsorbates resulting from the adsorptive desulphurization of a fuel in mobile use, in particular in a fuel cell system of a motor vehicle. The invention also relates to a fuel cell system and a motor vehicle with the fuel cell system in which such a method is performed.

In state-of-the-art technology, various devices and methods are known for desulphurizing fuels, in particular liquid fuels, in a fuel cell system. Basically, a distinction can be made between hydrogenating desulphurization and adsorptive desulphurization. In the widespread hydrogenating desulphurization method, desulphurization takes place at significantly higher temperatures than in adsorptive desulphurization.

A fuel cell system is known from EP 2 985 830 A1 in which hydrogenating desulphurization is performed. As part of the hydrogenating desulphurization method, cathode exhaust gas is introduced into a heat exchanger of a desulphurization unit. In addition, anode exhaust gas is conveyed directly to a desulphurization catalyst for the introduction of heat and hydrogen. A separate hydrogen supply unit is provided for this purpose. According to EP 2 985 830 A1, sulphur is broken down from raw material in a catalytic method using heat and combined with hydrogen and anode exhaust gas to form hydrogen sulphide and adsorbed. However, the hydrogenating desulphurization shown is only suitable for stationary applications as it requires long lingering times, high temperatures and high pressures.

For mobile applications, adsorptive desulphurization could therefore be an option. In the case of known adsorptive desulphurization, however, regeneration measures are necessary which rely on solvents or thermal regeneration, which are difficult to implement in mobile applications and lead to a complex system structure and correspondingly high costs.

The object of this invention is to at least partially take into account the problems described above. In particular, it is the object of the present invention to provide a fuel cell system, a method and a motor vehicle by means of which desulphurization for fuels in a fuel cell system can be implemented in mobile applications in a simple, space-saving, efficient and correspondingly cost-effective manner.

The preceding object is solved by the claims. In particular, the preceding object shall be solved by the fuel cell system according to claim 1, the method according to claim 8 and the motor vehicle according to claim 15. Further advantages of the invention result from the dependent claims, the description and the drawings. Features and details which are described in connection with the fuel cell system naturally also apply in connection with the method in accordance with the invention, the motor vehicle in accordance with the invention and vice versa in each case, so that with regard to the disclosure of the individual aspects of the invention, reference is or can always be made to each other.

According to a first aspect of the present invention, a fuel cell system is provided. The fuel cell system comprises a fuel cell stack with an anode portion and a cathode portion. The fuel cell system further comprises a reformer for reforming fuel for use in the anode portion of the fuel cell stack. In addition, the fuel cell system comprises a fuel tank for providing the fuel to the reformer, wherein downstream of the fuel tank and upstream of the reformer a desulfurization unit is located with an adsorber for adsorptively desulfurizing fuel conducted from the fuel tank via the desulfurization unit to the reformer. The adsorber is in fluid connection with the anode and cathode portion and/or an internal combustion engine of the fuel cell system by means of a regeneration fluid line, wherein fluid heated by the regeneration fluid line can be conveyed from the anode portion and the cathode portion and/or from the internal combustion engine to the adsorber.

In a further version of the present invention, the adsorber with anode and cathode portions is in fluid connection via at least one auxiliary power unit operated by the fuel cell system by means of a regeneration fluid line, wherein fluid heated by the regeneration fluid line can be conveyed from the anode and cathode portions via the auxiliary power unit to the adsorber. Due to the fact that fluid heated by the regeneration fluid line in the manner shown above can be conveyed from the auxiliary power unit and/or from the internal combustion engine (e.g. in the application of the fuel cell system incl. internal combustion engine in a hybrid vehicle) to the adsorber or the adsorbent in the adsorber are heated with thermal energy which is already generated in the fuel cell system anyway. In this way, the adsorber and the adsorbent located therein can be heated efficiently and thermally regenerated. Since there is no need for additional aids such as electrical resistance heating devices, the fuel cell system can also be made available in a particularly space-saving manner. Using the fuel cell system according to the invention, adsorptive desulphurization, for which subsequent regeneration is of decisive importance, can also be performed in an efficient and correspondingly cost-effective manner.

By using this invention, fuel cell systems in mobile applications can basically be operated with any fuel, since their sulphur components, which would destroy all fuel cell systems, including the SOFC variant (“Solid Oxide Fuel Cell”), which is particularly tolerant to sulphur compounds, practically immediately, can be efficiently and effectively removed.

Fuel is to be understood as fuel which is supplied in reformed form to the anode portion of the fuel cell stack in order to generate electrical energy there as part of a chemical reaction. Accordingly, the use of the fuel in the anode portion can be understood as a use there to generate electrical energy by means of the fuel cell stack. The fuel is preferably provided in liquid form in the fuel tank for this purpose. Accordingly, the desulphurization device is suitable for the desulphurization of liquid fuels in particular.

In one variant of the invention, the fuel cell system is especially configured as a SOFC system. In an embodiment in which the adsorber is in fluid connection with the internal combustion engine of the fuel cell system, the fuel cell system can be configured in the form of a hybrid system for a hybrid electric vehicle, as mentioned above. The heated fluid from the internal combustion engine is preferably understood to be exhaust gas from the internal combustion engine, which, with regard to a fuel cell system, has so far mostly been discharged unused into the environment of the hybrid electric vehicle.

By recirculating the exhaust gas from the internal combustion engine to the desulphurization unit or the adsorber in accordance with the invention, this already existing heat source can be used to regenerate the adsorber or the adsorbent in the adsorber efficiently and correspondingly cost-saving, as described above with reference to heated fluid of the auxiliary power unit.

Through the regeneration fluid line, the heated fluid can be conducted to the adsorber, in particular into it, whereby the adsorber and the adsorbent in the adsorber can be heated for the thermal regeneration of desulphurization adsorbates. By conducting or conveying the heated fluid into the adsorber, a particularly efficient heat input into the adsorbent in the adsorber can be achieved. Furthermore, desulphurization adsorbates can be efficiently removed from the adsorber in this way.

The features essential for the invention of this fuel cell system can also be easily retrofitted in conventional fuel cell systems. For this purpose, only the regeneration fluid line from the anode and cathode portions and/or from the at least one auxiliary power unit and/or from the internal combustion engine to the adsorber must be routed in the existing fuel cell system and the necessary connections to the respective components must be provided. This can be implemented in a cost-effective and space-saving way.

Ag-Al2O3 is preferably used as adsorbent. Extensive tests within the scope of the present invention have shown that this adsorbent can be used advantageously in the present fuel cell system and is particularly well suited for the adsorption of benzothiophene (BT), dibenzothiophene (DBT) and their derivatives, for example.

The regeneration fluid line may have several fluid connection portions. The fluid connection portions may intersect and/or be switched and/or separated by valves. The fluid connection portions may also be separated by one or more functional units, such as at least one auxiliary power unit operated by the fuel cell system.

The at least one auxiliary power unit operated or operable by the fuel cell system means a functional unit of the fuel cell system which is preferably activated or fully activated only by the operation of the fuel cell system.

According to a further embodiments of the present invention it is possible that in a fuel cell system the auxiliary power unit has an exhaust gas burner which is located on the reformer for heating the reformer, whereby the exhaust gas burner, in particular a first exhaust gas burner unit, is in fluid connection with the adsorber by means of the regeneration fluid line. Tests performed during the development of this invention have shown that, in particular, heated fluid from the exhaust gas burner is suitable for heating and regenerating the adsorbent in the adsorber efficiently and safely with regard to a chemical reaction with the adsorbent. The exhaust gas burner is preferably located in a ring around the reformer, whereby in a variant of the invention it has a first exhaust gas burner unit and a second exhaust gas burner unit, which are separated from each other in terms of flow technology and can, for example, both be configured in a semi-annular shape. This allows the reformer to be heated over as large a contact area as possible. In addition, the exhaust gas burner can thus be provided in a space-saving manner with the largest possible volume in the fuel cell system. This in turn means that as much heated fluid as possible can be provided and used to heat and regenerate the adsorbent in the adsorber. A fluid connection can also be established between the exhaust burner and the adsorber in a particularly simple and space-saving manner.

Furthermore, in a fuel cell system according to the invention, it is possible that the exhaust gas burner, in particular a first exhaust gas burner unit, is in fluid communication with a fluid connection of the cathode portion for conveying cathode portion exhaust gas into the exhaust gas burner by means of the regeneration fluid line. The exhaust gas burner is therefore understood to be an exhaust gas burner for the at least partial conversion of cathode portion exhaust gas which is conveyed from the cathode portion to the exhaust gas burner, in particular by enrichment with anode exhaust gas. For this purpose, the exhaust gas burner preferably has a catalyst with which the cathode exhaust gas can be burned, preferably without flames, and heated accordingly. A start burner can also be located in or on the exhaust gas burner, through which the exhaust gas burner and thus also the exhaust gas flowing through it can be heated, especially during a start method of the fuel cell system. By using the cathode exhaust gas, an already heated fluid can be used, which is further heated in the exhaust burner. This allows the adsorbent in the adsorber to be regenerated efficiently.

In addition, it may be advantageous in a fuel cell system according to the present invention if the adsorber is in fluid communication with a fluid connection of the anode portion for conveying anode portion exhaust gas into the adsorber by means of the regeneration fluid line, preferably the regeneration fluid line and the anode regeneration fluid line. This allows the adsorber with anode exhaust gas or anode exhaust gas if adsorbent is used which is not active in an oxygen-containing atmosphere and would therefore have to be activated in a reduced environment to be supplied. The ingenious embodiment of the regeneration fluid line allows for a high degree of flexibility in the use of adsorbents, which means that the fuel cell system can also be used flexibly. Complex additional components that also require space in the fuel cell system can be dispensed with.

Furthermore, it is possible in a fuel cell system according to the invention that a humidification unit for humidifying the heated fluid which is conveyed to the adsorber is located in the regeneration fluid line downstream of the auxiliary power unit and/or the internal combustion engine and upstream of the adsorber. Tests performed within the scope of this invention have shown that the exhaust gas used from an auxiliary power unit, in particular from the exhaust gas burner, has a positive effect on the regeneration of the desulphurization adsorbates.

In general, it was found that the exhaust gas composition has a surprisingly large influence on the regeneration performance. For example, a test with benzothiophen showed that the sulphur content of regenerated desulphurization adsorbates could be reduced from 1.3 mg/g (in the conventional use of air) to 0.9 mg/g. This phenomenon has been detected in various tests. On the basis of this knowledge it was found out that the increased water content in the exhaust gas of the auxiliary power unit leads to this effect. This finding was confirmed by further experiments. Accordingly, the addition of water or water vapor to the heated fluid can have a positive effect on the regeneration of the desulphurization adsorbates. The inventive humidification unit can cause or influence this effect accordingly. Furthermore, an increased heat input in the adsorber can be achieved by increasing the water content in the heated exhaust gas.

In the case of a fuel cell system in accordance with the present invention, it may also be advantageous if an additional burner for further heating the heated fluid which is conveyed to the adsorber is located in the regeneration fluid line downstream of the auxiliary power unit and/or the internal combustion engine, and in particular downstream of the humidifying unit, and upstream of the adsorber. The additional burner can be understood as an emergency solution to ensure sufficient heating of the fluid and thus of the adsorbent. The regeneration of the desulphurization adsorbates can thus be operated reliably.

In addition, it has been found that it may be advantageous in a fuel cell system according to the invention if the auxiliary power unit, in particular a second exhaust gas burner unit, is located in an exhaust gas fluid line for discharging exhaust gas from the adsorber into the environment of the fuel cell system downstream of the adsorber. Such an arrangement allows desulphurization adsorbates to be removed particularly easily and further treated in the auxiliary power unit. The auxiliary power unit preferably has an exhaust gas burner which is located in an annular manner around the reformer, wherein the exhaust gas burner is configured in a variant of the invention with a first exhaust gas burner unit and a second exhaust gas burner unit which are separated from each other in terms of flow and can both, for example, be configured in a semi-annular manner. Here the exhaust gas burner, in particular the first exhaust gas burner unit, is in fluid connection with an adsorber inlet of the adsorber via the regeneration fluid line and in particular the second exhaust gas burner unit is in fluid connection with an adsorber output of the adsorber via the exhaust gas fluid line. Thus, the exhaust gas burner unit upstream of the desulphurization unit is separated from the exhaust gas burner unit downstream of the desulphurization unit in terms of flow technology. This leads to an advantageously compact construction of the fuel cell system.

According to another aspect of the present invention, a method is provided for performing a thermal regeneration of desulphurization adsorbates resulting from an adsorptive desulphurization of a fuel in a fuel cell system as described above. As described above, the adsorber is in fluid connection with the anode and cathode portions and/or an internal combustion engine of the fuel cell system by means of a regeneration fluid line. For the thermal regeneration of the desulphurization adsorbates, fluid heated by the regeneration fluid line is conveyed from the anode and cathode portions and/or from the internal combustion engine to the adsorber in order to heat up the adsorber.

In a further version of the method, the adsorber is in fluid connection with the anode and cathode portions via at least one auxiliary power unit operated by the fuel cell system by means of a regeneration fluid line, wherein, for the thermal regeneration of the desulphurization adsorbates, fluid heated by the regeneration fluid line is conveyed from the anode and cathode portions via the auxiliary power unit to the adsorber.

Thus, a method according to the invention has the same advantages as described in detail with regard to the fuel cell system according to the invention. Extensive tests within the scope of the invention have shown that Ag-Al2O3 is particularly suitable as an adsorbent for adsorptive desulphurization. Accordingly, Ag-Al2O3 is preferably used in the method. By using the heated fluid already present in the fuel cell system as described above, a complete regeneration of Ag-Al2O3 can be realized efficiently. For example, full thermal regeneration of Ag-Al2O3 after adsorption of benzothiophene (BT), dibenzothiophene (DBT) or their derivatives can be efficiently achieved.

According to another aspect of the present invention, the auxiliary power unit comprises an exhaust gas burner located thereon for heating the reformer, wherein the exhaust gas burner, in particular a first exhaust gas burner unit, is in fluid connection with the adsorber by means of the regeneration fluid line and, for thermal regeneration of the desulfurization adsorbates, fluid heated by the regeneration fluid line is conveyed from the exhaust gas burner to the adsorber. As already described, the exhaust gas burner is configured in a variant of the invention with a first exhaust gas burner unit and a second exhaust gas burner unit, which are separated from each other in terms of flow and can, for example, both be configured in a semi-annular shape. This allows the advantages described above for the corresponding device feature to be achieved.

Furthermore, it is possible that the adsorber is in fluid communication with a fluid connection of the anode portion, for conveying anode portion exhaust gas into the adsorber, by means of the regeneration fluid line in a method according to the invention, wherein an activity value for the activity of an adsorbent in the adsorber in an oxygen-containing atmosphere is detected and if it is determined that the activity value is below a predefined threshold value, anode portion exhaust gas, e.g. via the exhaust gas burner is conveyed into the adsorber. In order to make the best use of the reducing effect of the anode exhaust gas, it is advantageous to convey it directly into the adsorber. This ensures reliable operation of the fuel cell system and reliable regeneration of the desulphurization adsorbates, even when different fuels containing sulphur are used. The activation value can be detected with a suitable sensor, in particular with a suitable material sensor for detecting the material composition of the adsorbent.

According to another variant of the present invention it is possible that in a method downstream of the auxiliary power unit and/or the internal combustion engine and upstream of the adsorber a humidification unit is located, whereby the heated fluid upstream of the adsorber is humidified by means of the humidification unit before it is conveyed into the adsorber. As shown above, it has surprisingly been shown that heated fluid with a defined high moisture content can significantly increase the effectiveness in regenerating desulfurization adsorbates. It may also be advantageous if, for example using a suitable humidity sensor, the moisture content in the heated fluid is detected and the heated fluid is moistened by the moistening unit if the detected moisture content is below a predefined threshold value. The moisture content of the heated fluid can also be advantageously adjusted to a predefined moisture content. This allows the desired regeneration effect to be achieved in a targeted manner. Tests performed within the scope of this invention have also shown that the desired thermal regeneration can be performed at particularly low temperatures by means of an appropriately moist or humidified heated fluid. By increasing the moisture content of the heated fluid, the operating temperature required for regeneration could be reduced from approx. 525° C. to approx. 450° C., for example. This allows the regeneration of the desulphurization adsorbates to be performed even more efficiently.

It may also be advantageous if an additional burner is located downstream of the auxiliary power unit and/or the internal combustion engine, and in particular downstream of the humidification unit, and upstream of the adsorber in a method in accordance with the invention, wherein in the regeneration fluid line upstream of the adsorber the temperature of the heated fluid is detected and when it is determined that the detected temperature of the heated fluid is below a predefined threshold value, the heated fluid upstream of the adsorber is further heated by means of the additional burner before it is conveyed into the adsorber. This ensures that the heated fluid at and/or in the adsorber always reaches the desired high temperature. The temperature can be detected by at least one temperature sensor. The at least one temperature sensor can be located in the regeneration fluid line and/or in an auxiliary power unit. It is also possible for exhaust gas from the internal combustion engine to be mixed with ambient air in order to adjust the temperature of the heated fluid or the regeneration temperature at and/or in the adsorber accordingly. For example, if the temperature of the heated fluid is found to be too high, the heated fluid can be mixed with ambient air. This enables the regulation of the temperature of the heated fluid in a simple, cost-effective and space-saving way.

In addition, it is possible that in a method according to the present invention the following steps are performed within the thermal regeneration of the desulphurization adsorbates:
heating adsorbent in the adsorber to a first temperature by means of heated fluid from the anode portion and cathode portion (5b) and/or the auxiliary power unit and/or from the internal combustion engine,
a second temperature is higher than the first temperature for the decomposition of adsorbed components of the fuel and evaporation of the decomposed components,
decomposition of intermediate products and regeneration of the adsorbent at a third temperature higher than the second temperature, and
cooling the adsorbent and/or adsorber to a fourth temperature lower than the first temperature.

This approach has proved to be particularly effective in experiments performed in the context of the present invention. Heating to the third temperature by using the heated fluid in accordance with the invention is a corresponding advantage. Cooling of the adsorbent is preferably performed by means of air, which is used to flush the adsorber. This is particularly cost-effective. Flushing with air is preferably performed using a blower.

In a method according to the invention, it may be advantageous if the first temperature is in a range between 100° C. and 350° C., in particular in a range between approx. 150° C. and approx. 300° C., the second temperature is in a range between 350° C. and 450° C., in particular in a range between approx. 420° C. and approx. 440° C., and/or the third temperature is in a range between 450° C. and 550° C., in particular in a range between approx. 480° C. and approx. 530° C. These values were used after extensive experiments to achieve the best results regarding an effective regeneration of the desulphurization adsorbates. The third temperature was found to be preferably between 450° C. and 530° C., particularly between 500° C. and 530° C. With targeted humidification of the heated fluid, as described in detail above, the third temperature is preferably in the range between 450° C. and 460° C.

Another aspect of the present invention is to provide a motor vehicle with a fuel cell system as described in detail above, which is configured to perform a method as described in detail above. Thus, the motor vehicle according to the invention also has the same advantages as those described in detail above with regard to the fuel cell system in conformity with the invention and the method in conformity with the invention. When using the internal combustion engine, the vehicle is preferably configured as a hybrid electric vehicle.

Further measures to improve the invention result from the following description of various embodiments of the invention, which are shown schematically in the figures. All features and/or advantages resulting from the claims, the description or the drawing, including constructive details and spatial arrangements, may be essential to the invention both for themselves and in the various combinations.

Is it shown schematically:

FIG. 1 block diagram to illustrate a fuel cell system according to a first embodiment of the present invention,

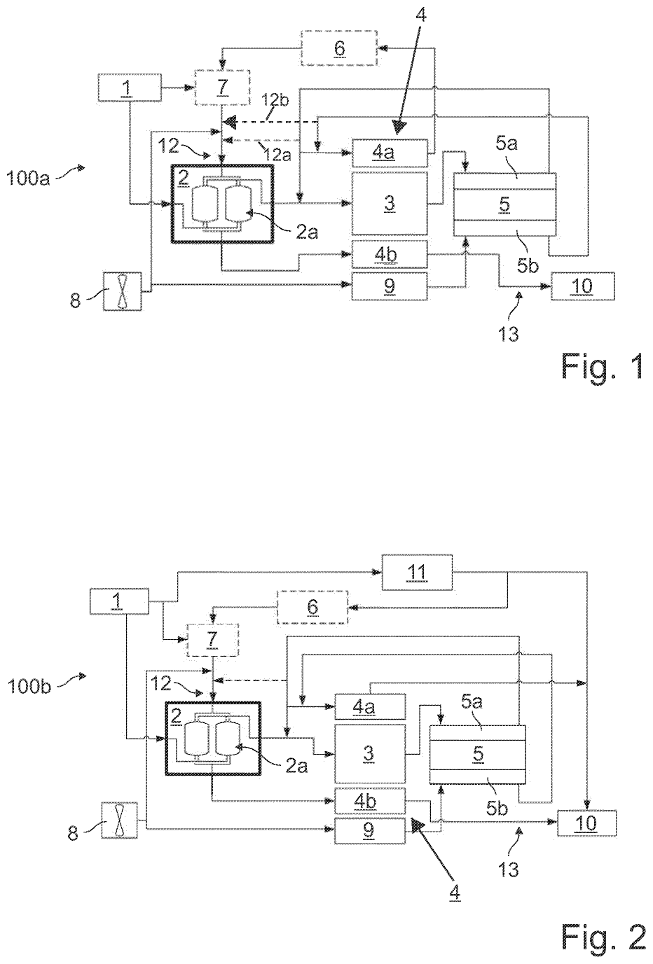

FIG. 2 block diagram for representing a fuel cell system according to a second embodiment of the present invention,

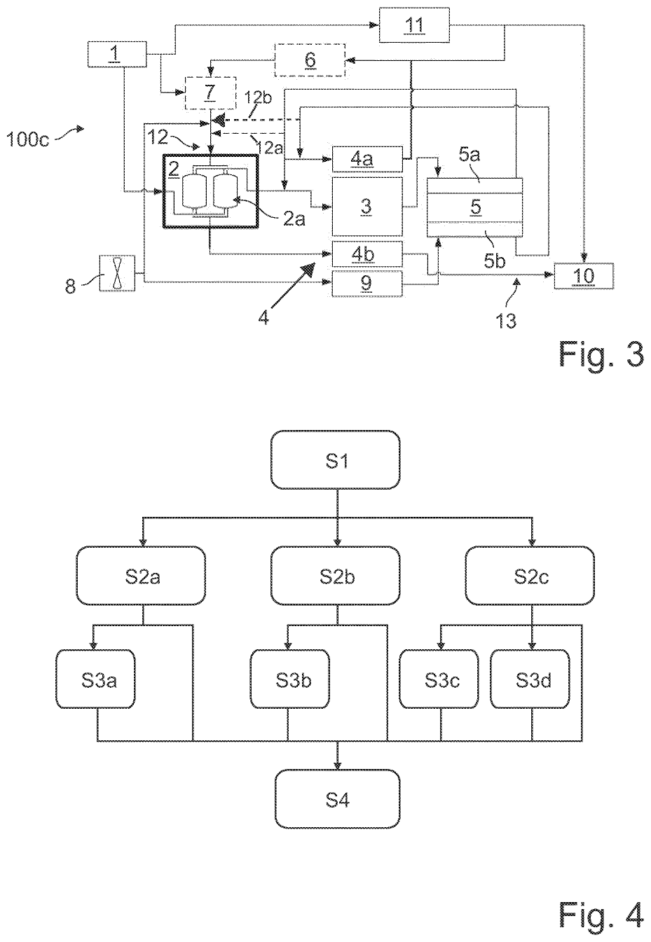

FIG. 3 block diagram to represent a fuel cell system according to a third embodiment of the present invention,

FIG. 4 a flow chart to explain a method according to an embodiment according to the invention.

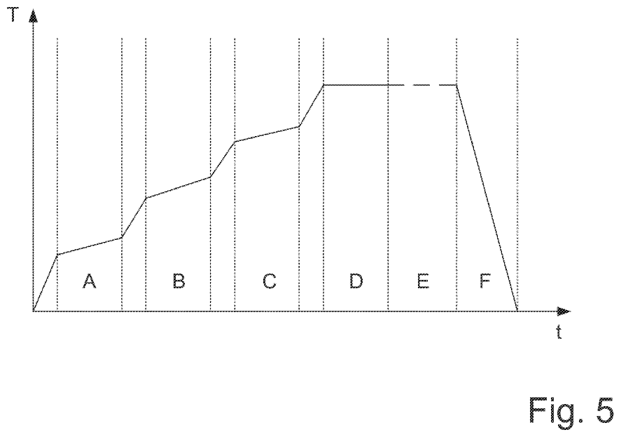

FIG. 5 time diagram explaining a method according to an embodiment.

Elements with the same function and mode of action have the same reference signs in FIGS. 1 to 5.

FIG. 1 schematically shows a fuel cell system 100a according to a first embodiment. The fuel cell system 100a comprises a fuel cell stack 5 with an anode portion 5a and a cathode portion 5b. The fuel cell system 100a further comprises a reformer 3 for reforming fuel for use in anode portion 5a of fuel cell stack 5. In addition, the fuel cell system 100a has a fuel tank 1 to provide the fuel for the reformer 3. A desulfurization unit 2 with an adsorber 2a for adsorptive desulfurization of fuel, which is conducted from the fuel tank 1 via the desulfurization unit 2 to the reformer 3, is located downstream of the fuel tank 1 and upstream of the reformer 3.

The adsorber 2a is in fluid connection with an auxiliary power unit 4 operated by the fuel cell system 100a with an exhaust gas burner 4a, 4b by means of a regeneration fluid line 12. Accordingly, heated fluid can be conveyed through the regeneration fluid line 12 from the auxiliary power unit 4 to the adsorber 2a.

In a dashed variant, the adsorber 2a is additionally or instead directly connected to the fuel cell stack via the anode regeneration fluid line 12a, with which anode exhaust gas from the fuel cell stack 5 is conveyed to the adsorber 2a, and via the cathode regeneration fluid line 12b, with which cathode exhaust gas from the fuel cell stack 5 is conveyed to the adsorber 2a.

The exhaust burner 4a, 4b is located to heat the reformer 3 at or annularly around it. The exhaust gas burners 4a, 4b are configured with a first exhaust gas burner unit 4a and a second exhaust gas burner unit 4b, which are separated from each other in terms of flow technology and are, for example, both configured in a semi-annular shape. The first exhaust gas burner unit 4a is also in fluid communication with a cathode portion 5b fluid connection for conveying cathode portion exhaust gas into the exhaust gas burner through the regeneration fluid line 12.

In the fuel cell system 100a shown in FIG. 1, the adsorber 2a is also in fluid communication with a fluid connection of the anode portion 5a, for conveying anode portion exhaust gas into the adsorber 2a, by means of the regeneration fluid line 12 or the anode regeneration fluid line 12a.

Furthermore, a humidification unit 6 for humidifying the heated fluid, which is conveyed to the adsorber, is located in the regeneration fluid line 12 downstream of the auxiliary power unit 4, in particular the first exhaust gas burner unit 4a, and upstream of the adsorber 2a. Downstream of the auxiliary power unit 4, in particular the first exhaust gas burner unit 4a, and downstream of the humidifying unit 6 and upstream of the adsorber 2a, an additional burner 7 is located for further heating of the heated fluid which is conveyed to the adsorber.

The auxiliary power unit 4, in particular the second exhaust gas burner 4b, is located in an exhaust gas fluid line 13 for discharging exhaust gas of the adsorber 2a into the environment or to an output 10 of the fuel cell system 100a downstream of the adsorber 2a.

The fuel cell system 100a also has a blower 8 which is in fluid connection with the adsorber 2a for rinsing. The blower 8 is also in fluid connection with a preheater 9, which is located to preheat the cathode portion 5b and is correspondingly in fluid connection with it.

FIG. 2 shows a fuel cell system 100b according to a second embodiment. The fuel cell system 100b shown in FIG. 2 essentially corresponds to the fuel cell system 100a shown in FIG. 1. In order to avoid a redundant description, only the distinguishing features between the two embodiments are subsequently described.

The fuel cell system 100b according to FIG. 2 has an internal combustion engine 11. The fuel cell system 100b shown is configured as a drive system for a hybrid electric vehicle. According to this embodiment, the adsorber 2a is in fluid connection with the internal combustion engine 11 by means of the regeneration fluid line 12, whereby heated fluid can be conveyed from the internal combustion engine 11 to the adsorber 2a by means of the regeneration fluid line 12.

FIG. 3 shows a fuel cell system 100c according to a third embodiment. The fuel cell system 100c shown in FIG. 3 corresponds essentially to the fuel cell systems 100a, 100b shown in FIG. 1 and FIG. 2. In order to avoid a redundant description, only the distinguishing features between the different embodiments are subsequently described.

The fuel cell system 100c according to FIG. 3 has, like the fuel cell system 100b according to the second embodiment, an internal combustion engine 11. According to the third embodiment, the adsorber 2a is in fluid connection with the internal combustion engine 11 and the auxiliary power unit 4 by means of the regeneration fluid line 12, whereby fluid heated by the regeneration fluid line 12 can be conveyed from the internal combustion engine 11 and from the auxiliary power unit 4 to the adsorber 2a. In addition, the anode regeneration fluid line 12a and the cathode portion regeneration fluid line 12b are shown in dotted lines.

With reference to FIG. 4, a method for performing a thermal regeneration of desulphurization adsorbates resulting from an adsorptive desulphurization of a fuel in a fuel cell system 100a in accordance with the first embodiment form is then described. The adsorptive desulfurization is based on selective interaction of heterocyclic sulfur compounds and the surface of the adsorbent. To desulphurization the fuel, it only has to be pumped through the adsorber with a low volume flow (Liquid Hourly Space Velocity LHSV preferably less than 1.7 h−1). If the adsorbent is loaded, i.e. if, for example, 10 ppmw sulphur is reached at the adsorber output, either the adsorbent must be exchanged or regenerated. For regeneration, the fuel in the adsorber must be emptied. This results in a volume of approx. 0.8 liters of fuel per liter of adsorbent.

In the method subsequently explained with reference to FIG. 4, for thermal regeneration of the desulphurization adsorbates, fluid heated by the regeneration fluid line is conveyed from the auxiliary power unit 4 to the desulphurization unit 2 for heating the adsorber 2a.

More precisely, in a first step S1, heated fluid is first conveyed or directed through the regeneration fluid line 12 from the auxiliary power unit 4 in the direction of the adsorber 2a in order to heat the adsorber 2a for the thermal regeneration of the desulphurization adsorbates. To be more precise, the heated fluid is led through the regeneration fluid line 12 from the exhaust gas burner, in particular the first exhaust gas burner unit 4a, to the adsorber 2a.

In a second step, S2a, an activity value is determined for the activity of an adsorbent in the adsorber in an oxygen-containing atmosphere. If it is determined that the activity value is below a predefined threshold, the method proceeds to step 3a. There, anode portion exhaust gases are conveyed into the exhaust gas burner through the regeneration fluid line 12. If it is determined that the activity value is greater than or equal to the predefined threshold, the method proceeds directly to step S4.

In a step S2b following step S1, a moisture content of the heated fluid is also detected. If it is found in step S2b that the moisture content determined is below a predefined threshold, the method proceeds to step S3b. There the heated fluid is moistened upstream of the adsorber 2a by means of the moistening unit 6 before it is conveyed into the adsorber 2a. If it is found that the moisture content detected is greater than or equal to the predefined threshold, the method proceeds directly to step S4.

In a step S2c following step S1, the temperature of the heated fluid is also detected upstream of adsorber 2a. If it is determined in step S2c that the detected temperature is below a predefined first threshold value, the method proceeds to step S3c. There the heated fluid is further heated upstream of the adsorber 2a by means of the additional burner 7 before it is conveyed into the adsorber 2a. If it is determined that the detected temperature of the heated fluid is greater than or equal to a predefined second threshold value greater than the first predefined threshold value, the method proceeds to step S3d. There the heated fluid is mixed with air, especially ambient air, to lower the temperature of the heated fluid (shown only with reference to FIG. 2). If it is determined that the detected temperature of the heated fluid is greater than or equal to the predefined first threshold and less than the predefined second threshold, the method proceeds directly to step S4.

In step S4, the heated and, if necessary, post-treated fluid is conveyed into the adsorber 2a.

With reference to FIG. 5, a method according to a further embodiment of the invention is then explained in which, in particular, a predefined temperature curve for desulphurization or desulphurization including regeneration is presented.

According to the method shown in FIG. 5, the adsorbent in the adsorber 2a is heated to a temperature of approx. 150° C. in a first step A by means of heated fluid from the auxiliary power unit 4 and/or from the internal combustion engine 11.

In a second step B, adsorbed components of the fuel are decomposed and evaporated at a temperature of approx. 300° C. In this step, the remaining liquid fuel is vaporized.

In a third step C, adsorbed components are further decomposed and evaporated at a temperature of approx. 450° C. Steps B and C can also be performed in a single step.

In a fourth step D, intermediate products are decomposed at a temperature of approx. 525° C. and regeneration of the adsorbent is initiated. If water or steam is added in a targeted manner by the humidification unit 6, the required temperature in step D can be lowered to approx. 450° C.

In a fifth, optional step E, the adsorbent is activated using various gases, in particular an anode portion exhaust gas. The fifth step E can be performed at least partially at the same time as the fourth step D. The temperature in the fifth step E depends on the adsorbent used.

In a final sixth step, the adsorbent and thus also the adsorber 2a are cooled to a temperature of approx. 20° C. by flushing with air, whereby this flushing method preferably takes place indirectly, so that there is no direct contact between the air and the adsorber 2a.

In addition to the embodiments described above, the invention naturally permits further embodiment principles. For example, at least one auxiliary power unit may alternatively or additionally have a starting burner and/or another heat source which are operated in the fuel cell system anyway and can generate the heated fluid in question.

### REFERENCE CHARACTER LIST

1 Fuel tank
2 Desulphurization unit
2a Adsorber
3 Reformer
4 Auxiliary power unit (exhaust burner)
4a First exhaust gas burner unit
4b Second exhaust gas burner unit
5 Fuel cell stack
5a Anode portion
5b Cathode portion
6 Humidification unit
7 Additional burner
8 Blower
9 Preheater
10 Output
11 Internal combustion engine
12 Regeneration fluid line
12a Anode regeneration fluid line
12b Cathode regeneration fluid line
13 Exhaust gas fluid line
100a, 100b, 100c Fuel cell system

1. A fuel cell system comprising a fuel cell stack having an anode portion a cathode portion, a reformer for reforming fuel for use in the anode portion of the fuel cell stack, and a fuel tank for providing the fuel to the reformer, wherein downstream of the fuel tank and upstream of the reformer there is located a desulphurization unit with an adsorber for the adsorptive desulphurization of fuel, which is conducted from the fuel tank via the desulphurization unit to the reformer, wherein the adsorber has at least an anode portion and cathode portion or an internal combustion engine of the fuel cell system is in fluid connection by means of a regeneration fluid line, wherein fluid heated by the regeneration fluid line can be conveyed from at least the anode portion and cathode portion or from the internal combustion engine to the adsorber.

2. The fuel cell system according to claim 1,
wherein
the adsorber with anode portion and cathode portion is in fluid connection by means of a regeneration fluid line via at least one auxiliary power unit operated by the fuel cell system, wherein fluid heated by the regeneration fluid line can be conveyed from the anode portion and cathode portion via the auxiliary power unit to the adsorber.

3. The fuel cell system according to claim 2,
wherein
the auxiliary power unit has an exhaust gas burner, which is located for heating the reformer, wherein the exhaust gas burner, is in fluid connection with the adsorber by means of the regeneration fluid line.

4. The fuel cell system according to claim 3,
wherein
the exhaust gas burner is in fluid communication with a fluid connection of the cathode portion for conveying cathode exhaust gas into the exhaust gas burner.

5. The fuel cell system according to claim 2, wherein
the adsorber is in fluid communication with a fluid connection of the anode portion for conveying anode portion exhaust gas into the adsorber by means of the regeneration fluid line, preferably the regeneration fluid line and the anode portion regeneration fluid line.

6. The fuel cell system according to claim 2,
wherein
a humidification unit for humidifying the heated fluid, which is conveyed to the adsorber, is at least located in the regeneration fluid line downstream of the auxiliary power unit or the internal combustion engine and upstream of the adsorber.

7. The fuel cell system according to claim 2, wherein
an additional burner for further heating the heated fluid, which is conveyed to the adsorber, is at least located in the regeneration fluid line downstream of the auxiliary power unit or the internal combustion engine.

8. The fuel cell system according to claim 2, wherein
the auxiliary power unit is located in an exhaust gas fluid line for discharging exhaust gas of the adsorber into the environment of the fuel cell system downstream of the adsorber.

9. A method for performing a thermal regeneration of desulphurization adsorbates, which result from an adsorptive desulphurization of a fuel, in a fuel cell system comprising a fuel cell stack having an anode portion and a cathode portion, a reformer for reforming fuel for use in the anode portion of the fuel cell stack, and a fuel tank for providing the fuel to the reformer, wherein downstream of the fuel tank and upstream of the reformer there is located a desulphurization unit with an adsorber for the adsorptive desulphurization of fuel, which is conducted from the fuel tank via the desulphurization unit to the reformer, wherein the adsorber has at least an anode portion and cathode portion or an internal combustion engine of the fuel cell system is in fluid connection by means of a regeneration fluid line, wherein fluid heated by the regeneration fluid line can be conveyed from at least the anode portion and cathode portion or from the internal combustion engine to the adsorber, wherein the adsorber has at least an anode portion and cathode portion or an internal combustion engine of the fuel cell system is in fluid connection by means of a regeneration fluid line, wherein, for thermal regeneration of the desulphurization adsorbates, fluid heated by the regeneration fluid line is conveyed from at least the anode portion and cathode portion or from the internal combustion engine to the adsorber for heating the adsorber.

10. The method according to claim 9,
wherein
the adsorber is in fluid communication with the anode portion and the cathode portion via at least one auxiliary power unit operated by the fuel cell system by means of a regeneration fluid line, wherein, for the thermal regeneration of the desulphurization adsorbates, fluid heated by the regeneration fluid line is conveyed from the anode portion and the cathode portion via the auxiliary power unit to the adsorber.

11. The method according to claim 10,
wherein
the auxiliary power unit has an exhaust gas burner which is located for heating the reformer, the exhaust gas burner, being in fluid connection with the adsorber by means of the regeneration fluid line and for thermal regeneration of the desulphurization adsorbates, fluid heated by the regeneration fluid line being conveyed from the exhaust gas burner to the adsorber.

12. The method according to claim 10,
wherein
the adsorber with a fluid connection of the anode portion for conveying anode portion exhaust gas into the adsorber by means of the regeneration fluid line is in fluid communication, wherein an activity value for the activity of an adsorbent in the adsorber in an oxygen-containing atmosphere is detected, and if it is determined that the activity value is below a predefined threshold value, anode portion exhaust gas is conveyed into the exhaust gas burner through the regeneration fluid line as part of the thermal regeneration of the desulphurization adsorbates.

13. The method according to claim 10,
wherein
a humidifying unit is located downstream of at least the auxiliary power unit or the internal combustion engine and upstream of the adsorber, wherein the heated fluid is humidified upstream of the adsorber by means of the humidifying unit before it is conveyed into the adsorber.

14. The method according to claim 10,
wherein
an additional burner is located downstream of at least the auxiliary power unit or the internal combustion engine and upstream of the adsorber, wherein the temperature of the heated fluid is detected in the regeneration fluid line upstream of the adsorber, and when it is determined that the detected temperature of the heated fluid is below a predefined threshold value, the heated fluid upstream of the adsorber is further heated by means of the additional burner before it is conveyed into the adsorber.

15. The method according to claim 10,
wherein
the following steps are performed within the scope of the thermal regeneration of the desulphurization adsorbates:
heating of adsorbent in the adsorber to a first temperature by means of heated fluid from at least the anode portion and cathode portion or the auxiliary power unit or from the internal combustion engine,
decomposition of absorbed compounds of the fuel and evaporation of the decomposed components at the second temperature are higher than at the first temperature,
decomposition of intermediate products and regeneration of the adsorbent at a third temperature higher than the second temperature, and
cooling at least said adsorbent or said adsorber to a fourth temperature lower than said first temperature.

16. The method according to claim 15,
wherein
at least the first temperature is in a range between 100° C. and 350° C., the second temperature is in a range between 350° C. and 450° C., or the third temperature is in a range between 450° C. and 550° C.

17. A motor vehicle having a fuel cell system comprising a fuel cell stack having an anode portion and a cathode portion, a reformer for reforming fuel for use in the anode portion of the fuel cell stack, and a fuel tank for providing the fuel to the reformer, wherein downstream of the fuel tank and upstream of the reformer there is located a desulphurization unit with an adsorber for the adsorptive desulphurization of fuel, which is conducted from the fuel tank via the desulphurization unit to the reformer, wherein the adsorber has an anode portion and a cathode portion or an internal combustion engine of the fuel cell system is in fluid connection by means of a regeneration fluid line, wherein fluid heated by the regeneration fluid line can be conveyed from the anode portion and cathode portion or from the internal combustion engine to the adsorber configured to perform a method for performing a thermal regeneration of desulphurization adsorbates, which result from an adsorptive desulphurization of a fuel, in the fuel cell system, wherein the adsorber has an anode portion and cathode portion or an internal combustion engine of the fuel cell system is in fluid connection by means of a regeneration fluid line, wherein, for thermal regeneration of the desulphurization adsorbates, fluid heated by the regeneration fluid line is conveyed from the anode portion and cathode portion or from the internal combustion engine to the adsorber for heating the adsorber.
